(19) United States
(12) Patent Application Publication
(10) Pub. No.: US 2024/0002689 A1
(43) Pub. Date: Jan. 4, 2024

(54) A Method For Obtaining Polymer Nanoparticle Dispersion Solution And An N-Type Conductive Ink

(71) Applicant: n-Ink AB, Norrköping (SE)

(72) Inventors: Simone FABIANO, Norrköping (SE); Magnus BERGGREN, Norrköping (SE); Marc-Antoine STOECKEL, Norrköping (SE); Chi-Yuan YANG, Norrköping (SE)

(21) Appl. No.: 18/037,381

(22) PCT Filed: Nov. 20, 2020
(86) PCT No.: PCT/EP2020/082815

§ 371 Date: May 17, 2023

(51) Int. Cl. C09D 11/52; C09D 11/36

(52) U.S. Cl. CPC C09D 11/52; C09D 11/36

(57) ABSTRACT

The present invention relates to a method for manufacturing a dispersion solution comprising nanoparticles of a rigid conjugated polymer having a dihedral angle from 0° to 20°, the method comprising the steps of: a) dissolving the rigid conjugated polymer in a first solvent system; b) combining the dissolved rigid conjugated polymer with a second solvent system thus obtaining a precipitate comprising the rigid conjugated polymer; c) collecting the precipitate comprising the rigid conjugated polymer; d) re-dispersing the precipitate in a third solvent system thus obtaining a dispersion solution comprising nanoparticles of the rigid conjugated polymer.

### TECHNICAL FIELD

The present invention relates to a method for manufacturing a dispersion solution comprising nanoparticles of a rigid conjugated polymer having a dihedral angle from 0° to 20° and a dispersion solution comprising nanoparticles of a rigid conjugated polymer manufactured by such a method. Further, the present invention relates to a method for manufacturing an n-type conductive ink, and an n-type conductive ink manufactured by such a method.

### BACKGROUND OF THE INVENTION

With their versatility, semiconducting and conducting polymers came up as a promising solution for bio- and opto-electronic applications due to their mechanical flexibility and high electrical conductivity while being compatible with large-area deposition methods, such as inkjet printing or spray-coating techniques. Inkjet printing is recognized as an efficient method for direct deposition of functional materials on flexible substrates in predesigned patterns owing to simple processing, low cost and higher adaptability for large scale fabrication of electronic devices, sensors, light emitting diodes, etc. However, inks used in inkjet printing mostly consist of metal nanoparticles and carbon materials such as graphene and carbon nanotubes, and few polymeric inks have been developed so far.

The large-area deposition techniques are greatly compatible with the use of dopants, allowing organic conductive polymers to reach metallic behaviors while lowering their charge injection barriers. This occurs via chemical or electrochemical processes upon addition of a molecular or polymeric doping entity to a conjugated polymeric matrix, mainly involving charge-transfer processes or acid-base exchanges. Depending on the combination of polymer and dopant used, p- or n-doping can occur. Both types may be employed in organic photovoltaics (OPV) or organic light-emitting diodes (OLED) and are required when considering complementary circuitry and devices. Such material should be easy to process and insoluble in common organic solvents used in multistep device fabrication. While p-type organic polymers have been massively developed and well-studied, led by the omnipresent commercially-available water-soluble p-type PEDOT-PSS in which one moiety (i.e. the poly(3,4-ethylenedioxythiophene), PEDOT) is doped through the negative charges induced by the sulfonates from the other compound (i.e. the poly(styrenesulfonate), PSS), only few examples of n-type conducting polymers have been reported so far, owing to their lack of stability. Further, most n-type conducting polymers can only be processed in halogenated solvents that are harmful for the environment.

One example of polymers being suitable in optical and electronic applications is rigid conjugated polymers, e.g. fully conjugated ladder polymers, in which all the backbone units on the polymer main-chain are r-conjugated and fused. These polymers have attracted great interest owing to their intriguing properties, remarkable chemical and thermal stability, and potential suitability as functional organic materials. In addition, they are distinct from conventional conjugated polymers in that the fused-ring constitution restricts the free torsional motion between the aromatic units along the backbone. Because of the diminished torsional defects, rigid conjugated polymers with fully coplanar backbones provide coherent r-conjugation, fast intra-chain charge transport, long exciton diffusion length, and strong r-r stacking interactions.

Since rigid conjugated polymers possess planar backbones with optimum r-electron delocalization and are free of torsional defects, they may be considered to be analogous to graphene nanoribbons, which combine the excellent charge transport property of graphene with opened band gaps as high-performance semiconducting materials. Furthermore, rigid conjugated polymers display potentially high thermal and optical stability as well as high resistance to chemical degradation. Such combination of unique properties of rigid conjugated polymers make them promising candidates for a wide range of applications.

However, rigid conjugated polymers suffer from poor processability. It is known that rigid conjugated polymers, such as poly(benzimidazobenzophenanthroline) (BBL), can only be dissolved in strong acidic solvents, such as methanesulfonic acid (MSA), concentrated sulfuric acid, and nitromethane/Lewis acid, e.g. gallium trichloride or aluminum trichloride. Such rigid conjugated polymers can be converted into nanoparticle dispersion solutions in water or alcohol solvents by employing solvent displacement method. This solvent displacement method usually includes three steps:
1) dissolving the polymer in MSA;
2) adding polymer-MSA solution to water/alcohol under vigorously stirring to form polymer nanoparticles;
3) washing the polymer nanoparticles by water/alcohol to remove residual MSA.

However, this method cannot be applied to provide polymer nanoparticle dispersion solution. In the above step 2, mixing of polymer-MSA solution with water/alcohol leads to oversized hard polymer particle aggregates due to the much stronger intermolecular interactions in the polymer. Further, MSA and concentrated sulfuric acid are strong acids with both high viscosity (11 mPa·s at 25° C.) and high boiling point (167° C. at 10 mmHg vacuum), which are hard to process and not suitable for large-scale preparation of nanoparticle dispersion solutions.

Therefore, there is a need to provide an environmentally friendly method for manufacturing polymeric nanoparticle dispersion solution suitable for ink fabrication, and for manufacturing a stable and high-performance n-type conducting ink suitable for large-area deposition techniques, in particular inkjet printing. Moreover, the method should be adaptable for large-scale manufacturing.

### SUMMARY OF THE INVENTION

In view of the above, the present invention relates to a method for manufacturing a dispersion solution comprising nanoparticles of a rigid conjugated polymer.

The term “rigid” in the context of the present invention means a conjugated polymer having a dihedral angle from 0° to 20°, preferably below 10°. The term “dihedral angle” in the context of the present invention is the angle between repeating units of the conjugated polymer. As mentioned above, the rigidity of the conjugated polymers of the present invention is a prerequisite for excellent charge transport ability combined with high stability, since torsional defects partially break the conjugation along the polymer backbone, resulting in decreased electronic delocalization, widened band gaps, increased numbers of trapped charges, and less effective intermolecular coupling.

The rigid conjugated polymers in the context of the present invention may have lowest unoccupied molecular orbital (LUMO) energy level E_{LU}MO below −3.9 eV. It should be understood that the term “below” in relation to a negative value is a negative value having a greater absolute value. In other words, the term “below” in the context of the present invention implies values being positioned to the left from −3.9 on the number line, e.g. −4.2, −5.8 and so forth.

The rigid conjugated polymer of the present invention may be an n-type rigid conjugated polymer.

Particularly suitable type of rigid conjugated polymers according to the present invention is conjugated ladder or ladder-type polymers. In general, ladder polymers are multiple stranded polymers with periodic linkages connecting the strands, resembling the rails and rungs of a ladder, and giving an uninterrupted sequence of adjacent rings that share two or more atoms. Conjugated ladder polymers are a specific subtype of ladder polymers in which all the fused rings in the backbone are r-conjugated. In addition, they are distinct from conventional conjugated polymers in that the fused-ring constitution restricts the free torsional motion in between the aromatic units along the backbone.

Stemming from the fused backbone, conjugated ladder polymers exhibit extraordinary thermal, chemical, and mechanical stability. Because of the diminished torsional defects, conjugated ladder polymers with fully coplanar backbones provide coherent r-conjugation, fast intra-chain charge transport, long exciton diffusion length, and strong r-r stacking interactions.

Examples of conjugated ladder or ladder-type polymers include poly(benzimidazobenzophenanthroline) (BBL), polyquinoxaline (PQL), poly(phenthiazine) (PTL), poly(phenooxazine) (POL), poly(p-phenylene) ladder polymers (LPPPs) and carbazole-fluorene-based ladder polymers. Preferably, the rigid conjugated polymer of the present invention is BBL, comprising from 10 to 10000, preferably 20 to 100, more preferably 30 to 50 repetitive units.

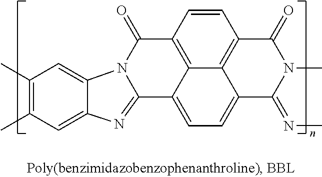

The method of the present invention comprises the steps of:
a) dissolving the rigid conjugated polymer in a first solvent system;
b) combining the dissolved rigid conjugated polymer with a second solvent system thus obtaining a precipitate comprising the rigid conjugated polymer;
c) collecting the precipitate comprising the rigid conjugated polymer;
d) re-dispersing the precipitate in a third solvent system thus obtaining a dispersion solution comprising nanoparticles of the rigid conjugated polymer.

All the steps of the method of the present invention are performed in air at ambient air pressure and humidity. It should be noted that the steps of the method according to the present invention are performed in the order listed above, i.e. step b) occurs after step a) is completed, step c) occurs after step b) is completed, and step d) occurs after step c) is completed. However, additional intermediate steps may be present in the method described above, e.g. steps of cooling, heating, diluting, evaporating, washing, drying or the like.

The first solvent system according to the present invention may comprise a first acid having a viscosity of 0.01-4 mPa·s at 25° C., a boiling point of 35-165° C. at atmospheric pressure, and pKa from −2 to 2. As may be understood from the above, the first acid has low viscosity and low boiling point, which significantly improves processability. The first acid serves as the main component in the first solvent system and can be selected from the group consisting of: 2,2-difluoroaceticacid, 2,2,2-trifluoroaceticacid (TFA), 2,2-difluoropropanoic acid, 2,2-difluoropropanoic acid, perfluoropropanoic acid, perfluorobutanoic acid, perfluoropentanoic acid, perfluorohexanoic acid and mixtures thereof, as shown below.

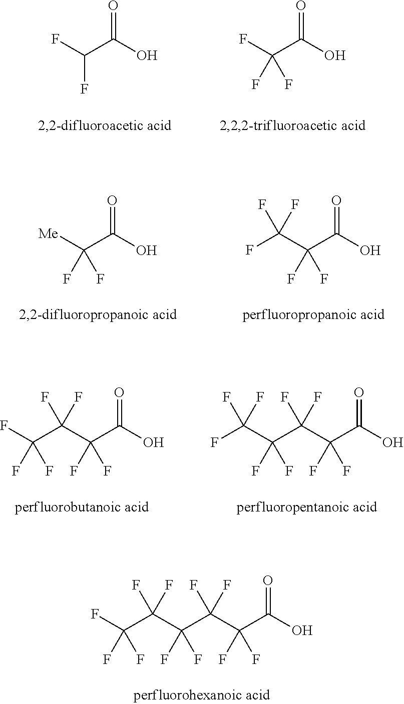

The first solvent system may further comprise a second acid having pKa=−12-−1. The second acid serves as the proton donor in the first solvent system in order to protonate the rigid conjugated polymer. The second acid may be selected from the group consisting of methanesulfonic acid (MSA), sulfuric acid, perchloric acid, nitric acid, sulfurofluoridic acid, sulfamic acid, sulfurochloridic acid, trifluoromethanesulfonic acid, benzenesulfonic acid, 4-methylbenzenesulfonic acid, 4-(trifluoromethyl)benzenesulfonic acid and mixtures thereof, as depicted below.

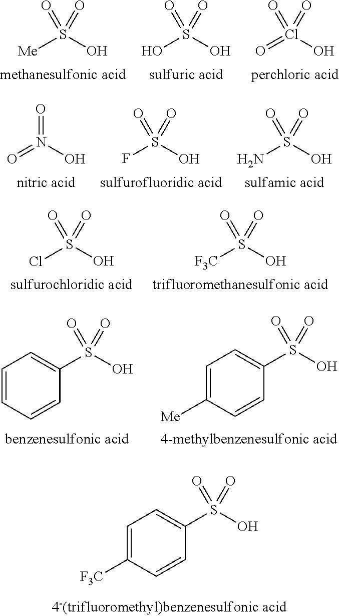

In a preferred embodiment, the first solvent system comprises TFA as the first acid and MSA as the second acid.

The volume ratio of the first acid and the second acid in the first solvent system may be from 95:5 to 5:95, preferably from 95:5 to 80:20, more preferably from 95:5 to 90:10. In other words, it is preferred that only a small amount of the second acid is used, bringing the advantage of improved processability of step a).

During step b), the dissolved rigid conjugated polymer obtained in step a) is combined with a second solvent system. During this step, a precipitate is obtained comprising the rigid conjugated polymer.

By the term “combining” is understood that the solution of the rigid conjugated polymer obtained in step a) is mixed with the second solvent system. Step b) may be performed by adding the second solvent system to the dissolved rigid conjugated polymer, or by adding the dissolved rigid conjugated polymer to the second solvent system.

By the term “precipitate” is meant a substance separated from a solution or suspension by chemical or physical change, usually as an insoluble amorphous or crystalline solid. The precipitate in the context of the present invention may be nanoparticles, particle aggregates, fiber-like structures or the like. The nature of the precipitate formed during step b) may be dependent on how step b) is performed. Thus, if the second solvent system is added to the dissolved rigid conjugated polymer, nanoparticles of the rigid conjugated polymer are normally formed. On the other hand, if the dissolved rigid conjugated polymer is added to the second solvent system, soft fiber-like particle aggregates of the rigid conjugated polymer are normally formed.

According to the present invention, the second solvent system may comprise an alcohol. Further, the second solvent system may comprise TFA. The volume ratio of TFA:alcohol in the second solvent system may be from 0:1 to 1:1. In other words, the second solvent system may consist of a pure alcohol or may comprise equal parts of TFA and alcohol. The alcohol may be selected from the group consisting of methanol, ethanol, propan-1-ol, propan-2-ol, butan-1-ol, 2-methylpropan-1-ol, 2-methylpropan-2-ol, 2-methylbutan-2-ol, ethane-1,2-diol, 2-methoxyethan-1-ol, 1-methoxypropan-2-ol and mixtures thereof, as illustrated below.

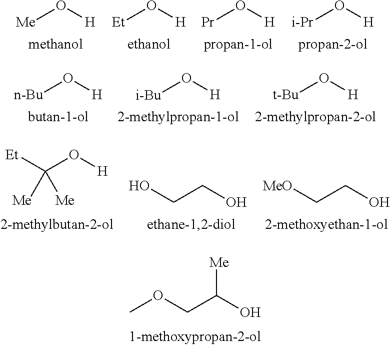

Preferably, the second solvent system comprises methanol, ethanol, isopropanol or mixtures thereof. The nature of the second solvent system may depend on how step b) is performed. Thus, if the second solvent system is added to the dissolved rigid conjugated polymer, the second solvent system preferably has the volume ratio of TFA:alcohol from 1:3 to 1:1. On the other hand, if the dissolved rigid conjugated polymer is added to the second solvent system, the second solvent system preferably consists of an alcohol only.

Addition of the second solvent system to the dissolved rigid conjugated polymer, or addition of the dissolved rigid conjugated polymer to the second solvent system may be performed at sunken temperatures, preferably at 0° C. Further, addition of the second solvent system to the dissolved rigid conjugated polymer, or addition of the dissolved rigid conjugated polymer to the second solvent system may be performed during stirring, preferably medium to vigorous stirring.

Completion of step b) may be visually observed since a distinct colour change may occur when the precipitate is formed.

During the next step c), the precipitate comprising the rigid conjugated polymer is collected. Step c) may be performed by centrifugation of vacuum filtration, depending on the nature of the precipitate obtained in step b). It is conceivable that the precipitate collected during step c) is washed in order to remove residual acids. The washing may be performed using a protic solvent, e.g. an alcohol/water mixture. The alcohol may be selected from the group mentioned above.

During step d), the precipitate obtained in step c) is re-dispersed in a third solvent system thus obtaining a dispersion solution comprising nanoparticles of the rigid conjugated polymer. Step d) may be accompanied by the step of levigating, e.g. by means of stirring crushing or ball milling. Further, step d) may be performed repeatedly several times, such that the residual acids are removed from the dispersion.

The third solvent system may be a protic solvent system and may comprise an alcohol selected from the group mentioned above. The third solvent system may be equivalent to the second solvent system. Preferably, the third solvent system is isopropanol. Further, the third solvent system may comprise water.

As mentioned above, the method of the present invention thus provides a nanoparticle dispersion solution of rigid conjugated polymer. As has been shown, the method of the present invention utilizes environmentally- and user-friendly solvents. Further, all the steps of the method disclosed above may be performed in air and are highly suitable for large scale manufacturing.

The present invention relates to a dispersion solution comprising nanoparticles of rigid conjugated polymer having a dihedral angle from 0° to 20° manufactured by the method described above.

The nanoparticle dispersion solution obtained by the method above may be used for manufacturing an n-type conductive ink. The present invention thus relates to a method for manufacturing an n-type conductive ink comprising the steps of:
a) dissolving a rigid conjugated polymer having a dihedral angle from 0° to 20° in a first solvent system;
b) combining the dissolved rigid conjugated polymer with a second solvent system thus obtaining a precipitate comprising the rigid conjugated polymer;
c) collecting the precipitate comprising the rigid conjugated polymer;
d) re-dispersing the precipitate in a third solvent system thus obtaining a dispersion solution comprising nanoparticles of the rigid conjugated polymer;
e) diluting the dispersion solution comprising nanoparticles of the rigid conjugated polymer with a fourth solvent system thus obtaining an ink;
f) adding an n-type polymeric cation to the ink, thus obtaining an n-type conductive ink.

Steps a)-d) have been described in detail above. Once a nanoparticle dispersion solution is obtained in step d), step e) of diluting the dispersion solution comprising nanoparticles of the rigid conjugated polymer with a fourth solvent system is performed, thus obtaining an ink. Step e) may be preceded by the step of concentrating the nanoparticles of the rigid conjugated polymer, e.g. by means of centrifuging.

The fourth solvent may comprise an alcohol, preferably selected from the group mentioned above. The concentration of the nanoparticles of the rigid conjugated polymer after step e) may be from 0.001 to 100 g/L.

During step f), an n-type polymeric cation is added to the ink obtained in step e), thus obtaining an n-type conductive ink. The n-type polymeric cation may be dissolved in an appropriate solvent, such as an alcohol selected from the group mentioned above. The concentration of the n-type polymeric cation may be from 0.01 to 100 g/L. The n-type polymeric cation is preferably an n-type polymeric dopant. The n-type polymeric dopant may be, linear polyethyleneimine (PEIₗᵢₙ), branched PEI (PEI_{bra}), ethoxylated PEI (PEIE) or mixtures thereof. The number of repetitive units in the n-type polymeric dopant may be from 2 to 10000, preferably from 5 to 1000, more preferably from 50 to 100 repetitive units.

The mass ratio polymeric cation/(polymeric cation+rigid conjugated polymer) during step f) may be from 0.01% to 99.99%, preferably from 0.1% to 90%, more preferably from 1% to 75%, most preferably from 20% to 50%.

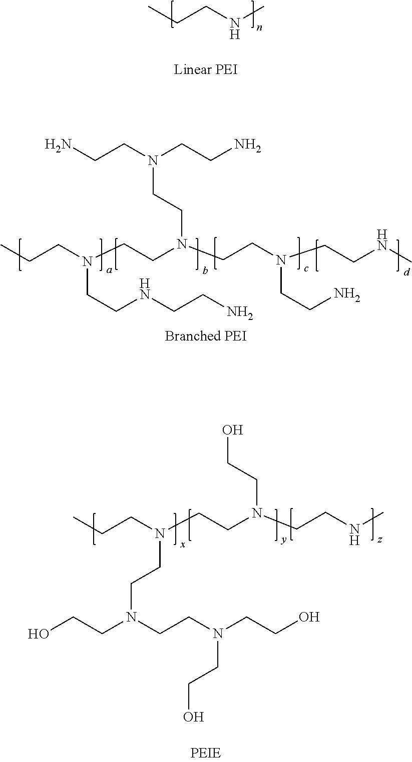

When the n-type polymeric cation is branched PEI, a, b, c and d are positive integers, such that the sum of these integers is from 5 to 10000, preferably from 10 to 1000, more preferably from 50 to 100.

When the n-type polymeric cation is ethoxylated PEI, x, y and z are positive integers, such that the sum of these integers is from 5 to 10000, preferably from 10 to 1000, more preferably from 50 to 100.

Step e) may be accompanied or followed by the step of sonicating the solution obtained in step e) in an ultrasonic bath in order to provide a homogenous mixture. The sonication time may be 1 hour.

The present invention further relates to an n-type conductive ink manufactured by the method described above. The n-type conductive ink thus comprises a rigid conjugated polymer having a dihedral angle from 0° to 20° and a polymeric cation.

The n-type conductive ink obtained by the method of the present invention may be spray-coated in air and ambient temperature, forming the film having thickness of from 20 nm to 1 mm. Thermal annealing may be required in order to enable the doping. The thermal annealing may be performed at temperatures from 100° C. to 200° C. for periods from 1 min to 120 min. Preferably, thermal annealing is performed at 150° C. for 120 min or 200° C. for 90 min. The thermal annealing should be performed under inert atmosphere. Alternatively, the film may be encapsulated prior to the thermal annealing.

This n-type conductive ink is suitable for large scale deposition methods, such as the spray-casting or inkjet printing technique. Due to its nature, this ink can be processed in air, and the low boiling point of the solvent employed does not require any thermal treatment for its drying.

### BRIEF DESCRIPTION OF THE DRAWINGS

Embodiments of the invention will now be described by way of example with reference to the accompanying drawings, of which:

FIG. 1 shows the steps of the method for manufacturing a nanoparticle dispersion solution of rigid conjugated polymer, and an n-type conductive ink comprising such a rigid conjugated polymer;

FIG. 2 illustrates ink particle size distribution determined by dynamic light scattering (DLS) analysis of BBL:PEIₗᵢₙ (a) and BBL:PEI_{bra} (b) ethanol-based n-type ink;

FIG. 3 shows the electrical conductivity of the n-type ink manufactured by the method of the present invention as a function of dopant content;

FIG. 4 depicts Seebeck coefficient of the n-type ink manufactured by the method of the present invention as a function of dopant content.

### DETAILED DESCRIPTION OF THE INVENTION

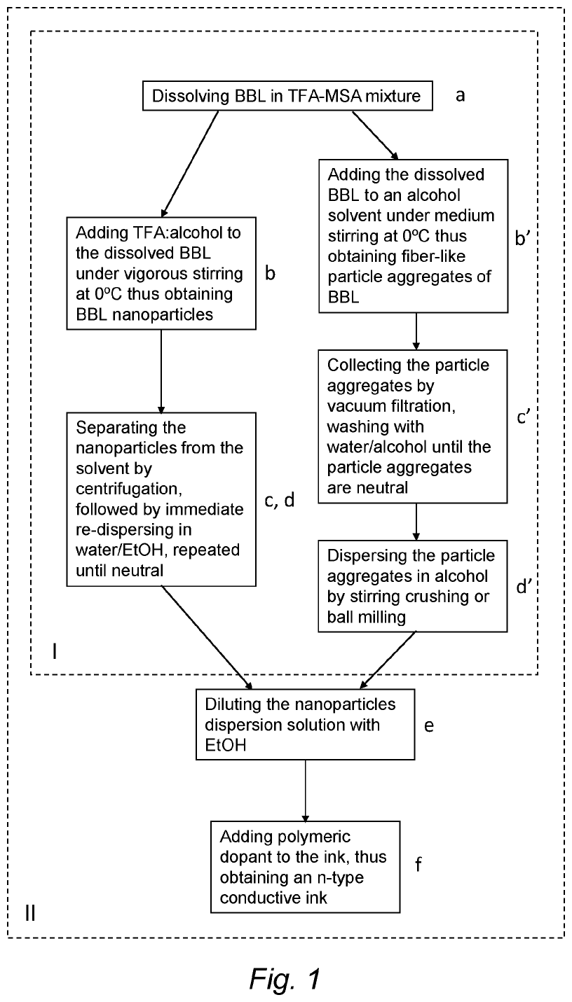

FIG. 1 comprises two blocks, block I and block II. Block I illustrates the steps of the method for manufacturing nanoparticle dispersion solution of rigid conjugated polymer. Block II depicts the steps of the method for manufacturing an n-type conductive ink comprising the rigid conjugated polymer.

As may be seen in block I of FIG. 1, two different embodiments of the method of manufacturing nanoparticle dispersion solution are shown.

BBL (M_{w}=60.5 kDa) was synthesized following the procedure reported in the prior art (Arnold, F. E. & Deusen, R. L. V. Preparation and properties of high molecular weight, soluble oxobenz[de]imidazobenzimidazoisoquinoline ladder polymer. Macromolecules 2, 497-502 (1969)). Linear PEI (Mₙ=2.5 kDa, PDI<1.3), branched PEI (Mₙ=10 kDa, PDI=1.5), MSA, and ethanol were purchased from Sigma-Aldrich and used as received.

According to the first embodiment depicted in the left part of block I, in step a) BBL was dissolved in a first solvent system comprising TFA:MSA mix solvent (volume ratio TFA:MSA=95:5˜ 80:20) obtaining a bright red solution.

In the subsequent step b), a second solvent system comprising TFA:alcohol mix solvent (1:3˜1:1) was added to the BBL TFA-MSA solution obtained in step a) under vigorous stirring at 0° C., until the colour of the solution turns into dark blue. The alcohol is selected from MeOH, EtOH, IPA or mixtures thereof.

During steps c) and d), the nanoparticles are separated from the solvent by centrifugation, and immediately re-dispersed in water/IPA. This step is repeated several times until residual acids are removed from the dispersion.

Turning the attention to the right part of block I shown in FIG. 1, another embodiment of the method is illustrated. Step a) of this embodiment is the same as described above, i.e. BBL was dissolved in a first solvent system comprising TFA:MSA mix solvent (volume ratio TFA:MSA=95:5˜80:20) obtaining a bright red solution.

In step b′), the BBL TFA:MSA solution obtained in step a) is added to EtOH under medium stirring at 0° C., forming soft fiber-like BBL particle aggregates. In this step, the colour changes from bright red to dark purple/black.

In the subsequent step c′), the soft fiber-like BBL particle aggregates are collected by vacuum filtration and washed several times by water/IPA until the particle aggregates are completely neutral. BBL particle aggregate solution is concentrated by centrifuging.

During step d′), the soft particle aggregates are levigated to form BBL nanoparticle dispersion solution using stirring crushing or ball milling in EtOH.

Both of the methods depicted in block I of FIG. 1 and described above provide nanoparticle dispersion solution comprising well dispersed BBL nanoparticles suitable for manufacturing an ink. It must be underlined that the method of the present invention utilizes environmentally friendly solvents.

Block II in FIG. 1 shows the method for manufacturing an n-type conductive ink according to the present invention.

In step e), the dispersion solution obtained in step d) or a dispersion solution obtained in step d′) is diluted to appropriate concentration (0.2 to 0.5 g/L) by alcohol solvents.

Finally, during step f), an EtOH-based solution of polymeric cation (linear PEI, branched PEI or PEIE) is added. The polymeric cation may act as a dopant. The concentration of the polymeric cation used in this particular embodiment is 30 g/L, but the person skilled in the art would understand that the concentrations may be varied. The mass ratio polymeric cation/(polymeric cation+BBL) was 50% for the PEIₗᵢₙ and PEI_{bra}, and 20% for PEIE.

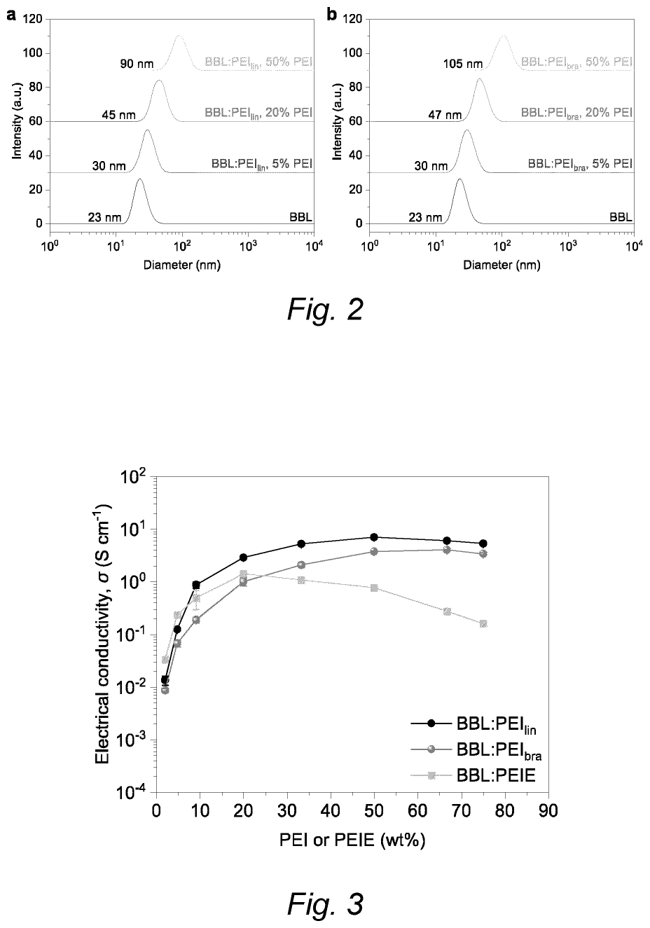

The BBL nanoparticles in the dispersion solution obtained by the method of the present invention have a diameter of about 20 nm (FIG. 2). The BBL nanoparticles are then washed in ethanol and mixed with either linear PEI (PEIₗᵢₙ) or branched PEI (PEI_{bra}) at different mass ratios and sonicated in ultrasonic bath for 1 hour to obtain the ethanol-based all-polymer conductive ink. The resulting ethanol-based ink is composed of BBL:PEI nanoparticles with size of 30-100 nm, depending on the PEI content, as shown in FIG. 2.

BBL:PEI thin films described below were fabricated by spray-casting in air, by means of a standard HD-130 air-brush (0.3 mm) with atomization air pressure of 2 bar. After spray-casting, the BBL:PEI thin films were annealed at 140° C. for 2 hours in N₂ glove box or under vacuum to get the conducting film.

Electrical conductivity and Seebeck coefficient measurements were done in a nitrogen-filled glovebox using a Keithley 4200-SCS semiconductor characterization system. 3 nm of chromium as adhesive layer and 47 nm of gold where thermally evaporated on cleaned glass substrates, through a shadow mask, forming electrodes with a channel length/channel width of 30 μm/1000 μm for the electrical and 0.5 mm/15 mm for Seebeck coefficient characterizations.

The electrical conductivity of BBL:PEI thin films is reported in FIG. 3, as a function of the dopant content. Pure BBL films have an electrical conductivity as low as 10⁻⁵ S cm⁻¹ in their pristine state. As may be seen in FIG. 3, the n-type BBL inks doped with linear PEI (PEIₗᵢₙ), branched PEI (PEI_{bra}) and PEIE show excellent n-type electrical conductivity after film-forming. When blended with PEI, the electrical conductivity increases to 0.10±0.02 S cm⁻¹ at 5 wt % PEI and saturates to 7.7±0.5 S cm⁻¹ for 50 wt % PEI content. Because of the high density of electron-donating amine groups in PEI, a 5 min treatment at 150° C. is enough to reach 1 S cm⁻¹ n-type conductivity, whereas the maximum conductivity of 7 S cm⁻¹ is obtained after 2 hours of annealing which is achieved for blends with 1:1 weight ratio. When BBL is doped with PEIE, it reaches a conductivity of 1.4±0.1 S cm⁻¹ at BBL:PEIE 5:1, while higher PEIE content leads to a degradation of the electrical performance. These electrical conductivities can be compared to PEDOT:PSS.

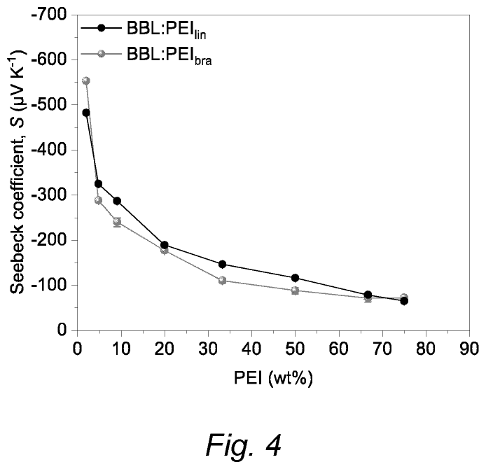

FIG. 4 depicts Seebeck coefficient of BBL with different dopants PEIₗᵢₙ and PEI_{bra}. As may be seen in FIG. 4, BBL:PEI shows large negative Seebeck coefficient of −480 to −65 μV/K, confirming that BBL:PEI is an n-type conducting polymer. The Seebeck coefficient decreases with increasing PEI content.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention.

1.-15. (canceled)

16. A method for manufacturing a dispersion solution comprising nanoparticles of a rigid conjugated polymer having a dihedral angle from 0° to 20°, said method comprising the steps of:
a) dissolving said rigid conjugated polymer in a first solvent system;
b) combining said dissolved rigid conjugated polymer with a second solvent system thus obtaining a precipitate comprising said rigid conjugated polymer;
c) collecting said precipitate comprising said rigid conjugated polymer;
d) re-dispersing said precipitate in a third solvent system thus obtaining a dispersion solution comprising nanoparticles of said rigid conjugated polymer.

17. The method according to claim 16, wherein said first solvent system comprises a first acid having a viscosity of 0.01-4 mPa·s at 25° C., a boiling point of 35-165° C. at atmospheric pressure, and pKa from −2 to 2, and a second acid having pKₐ=−12-−1.

18. The method according to claim 17, wherein said first acid is selected from the group consisting of 2,2-difluoroacetic acid, 2,2,2-trifluoroacetic acid (TFA), 2,2-difluoropropanoic acid, 2,2-difluoropropanoic acid, perfluoropropanoic acid, perfluorobutanoic acid, perfluoropentanoic acid, perfluorohexanoic acid or mixtures thereof, and the second acid is selected from the group consisting of methanesulfonic acid (MSA), sulfuric acid, perchloric acid, nitric acid, sulfurofluoridic acid, sulfamic acid, sulfurochloridic acid, trifluoromethanesulfonic acid, benzenesulfonic acid, 4-methylbenzenesulfonic acid, 4-(trifluoromethyl)benzenesulfonic acid or mixtures thereof.

19. The method according to claim 17, wherein the volume ratio of said first acid and said second acid in said first solvent system is from 95:5 to 5:95.

20. The method according to claim 16, wherein said second solvent system comprises an alcohol.

21. The method according to claim 20, wherein said alcohol is selected from the group consisting of methanol, ethanol, propan-1-ol, propan-2-ol, butan-1-ol, 2-methylpropan-1-ol, 2-methylpropan-2-ol, 2-methylbutan-2-ol, ethane-1,2-diol, 2-methoxyethan-1-ol, 1-methoxypropan-2-ol or mixtures thereof.

22. The method according to claim 20, wherein the volume ratio of TFA:alcohol in said second solvent system is from 0:1 to 1:1.

23. The method according to claim 16, wherein said third solvent system comprises an alcohol and optionally water.

24. The method according to claim 16, wherein said third solvent system is equivalent to said second solvent system.

25. The method according to claim 16, wherein said rigid conjugated polymer is a conjugated ladder polymer, preferably poly(benzimidazobenzophenanthroline) (BBL).

26. The method according to claim 16, wherein said step c) is performed by centrifugation of vacuum filtration.

27. The method according to claim 16, wherein a mass ratio polymeric cation/(polymeric cation+conjugated polymer) is from 0.01% to 99.99%, preferably 20-50%.

28. A dispersion solution comprising nanoparticles of rigid conjugated polymer having a dihedral angle from 0° to 20° manufactured by the method according to claim 16.

29. A n-type conductive ink manufactured by the method according to claim 16.

30. A method for manufacturing an n-type conductive ink, said method comprising the steps of:
a) dissolving a rigid conjugated polymer having a dihedral angle from 0° to 20° in a first solvent system;
b) combining said dissolved rigid conjugated polymer with a second solvent system thus obtaining a precipitate comprising said rigid conjugated polymer;
c) collecting said precipitate comprising said rigid conjugated polymer;
d) re-dispersing said precipitate in a third solvent system thus obtaining a dispersion solution comprising nanoparticles of said rigid conjugated polymer;
e) diluting said dispersion solution comprising nanoparticles of said rigid conjugated polymer with a fourth solvent system thus obtaining an ink;
f) adding an n-type polymeric cation to said ink, thus obtaining an n-type conductive ink.

31. The method according to claim 30, wherein said first solvent system comprises a first acid having a viscosity of 0.01-4 mPa·s at 25° C., a boiling point of 35-165° C. at atmospheric pressure, and pKa from −2 to 2, and a second acid having pKₐ=−12-−1.

32. The method according to claim 31, wherein said first acid is selected from the group consisting of 2,2-difluoroacetic acid, 2,2,2-trifluoroacetic acid (TFA), 2,2-difluoropropanoic acid, 2,2-difluoropropanoic acid, perfluoropropanoic acid, perfluorobutanoic acid, perfluoropentanoic acid, perfluorohexanoic acid or mixtures thereof, and the second acid is selected from the group consisting of methanesulfonic acid (MSA), sulfuric acid, perchloric acid, nitric acid, sulfurofluoridic acid, sulfamic acid, sulfurochloridic acid, trifluoromethanesulfonic acid, benzenesulfonic acid, 4-methylbenzenesulfonic acid, 4-(trifluoromethyl)benzenesulfonic acid or mixtures thereof.

33. The method according to claim 31, wherein the volume ratio of said first acid and said second acid in said first solvent system is from 95:5 to 5:95.

34. A dispersion solution comprising nanoparticles of rigid conjugated polymer having a dihedral angle from 0° to 20° manufactured by the method according to claim 30.

35. A n-type conductive ink manufactured by the method according to claim 30.
